(19) United States
(12) Patent Application Publication
(10) Pub. No.: US 2019/0385220 A1
(43) Pub. Date: Dec. 19, 2019

(54) Parametric Object Storage Management System

(71) Applicant: Maurence Anguh, Chicago, IL (US)

(72) Inventor: Maurence Anguh, Chicago, IL (US)

(21) Appl. No.: 16/010,681

(22) Filed: Jun. 18, 2018

(51) Int. Cl. G06Q 30/06; G06Q 50/16

(52) U.S. Cl. CPC G06Q 30/0645; G06Q 50/163; G06Q 30/0617

(57) ABSTRACT

A parametric object storage management system that provides real-time capabilities with trusted agents to optimize storage facility utilization for land, marine or aviation object. This system: 1) provides owner-input and requisite renter-searchable facility parameters for land, marine or aviation object storage; 2) enhances real-time determination of vacancy in a facility using Internet-based and geospatial technologies; 2) enhances utilization of secure facilities through trusted agents with the requisite qualifications, credentials, certifications, experience, and security clearances; and 4) is open and scalable to add-on components such as Artificial Intelligence (AI), Virtual Reality (VR) and marketplace tools.

### CROSS-REFERENCE TO RELATED APPLICATIONS

Not Applicable

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFSWEB)

Not Applicable.

### STATEMENT REGARDING PRIOR DISCLOSURES BY THE INVENTOR OR A JOINT INVENTOR

Not Applicable.

### BACKGROUND OF THE INVENTION

### Field of the Invention

This present invention relates to a parametric object storage management system. The system allows an owner to register its facility with parameters. Renters for land, marine or aviation object storage can search the system using various parameters.

### Background Art

The acreage reserved for land, marine or aviation object storage continues to increase rapidly. However, most storage facilities are either underutilized or vacant at certain periods as the owner is away or at other location. The underutilization of facilities can be attributed to the following factors:
1) Parameters: Inability to define the parameters of the requisite facility in real-time.
2) Capability: Limited real-time capability to determine vacancy at the facility.
3) Security: Lack of access security credentials to the facility.

Various systems and methods for vehicle parking have been described over the years. The following patents describe the prior art with its limitations:

In Patent No US20150332174, a “System and method for enhanced vehicle parking space utilization” is described for vehicles.

In Patent No WO2016040888, a “system and method to facilitate on demand parking” for vehicles is disclosed.

In Patent No US20150235148, a “System and Method for Reserving a Parking Space” is presented for vehicles.

In Patent No US20150058051, a “Property sharing platform” is disclosed for listing and publishing of parking spaces.

In U.S. Pat. No. 8,816,879, a “Computer-implemented system and method for managing interchangeable parking spaces” is presented to manage plurality of parking spaces for vehicles.

In Patent No US20140100894, a “System and method for reserving a parking space in a dwelling complex” is presented.

In Patent No US20090125341, “Coordinating and managing the rental of parking spaces” describes an internet-based parking space reservation and transaction method.

These existing patents disclose systems and methods that are rigid and nonparametric. The parametric object storage management system utilizes owner-input and renter-searchable parameters for land, marine or aviation object storage. Furthermore, the system is open and scalable for add-on components such as Artificial Intelligence (AI), Virtual Reality (VR) and marketplace tools.

### BRIEF SUMMARY OF THE INVENTION

This invention provides a system and method to enhance the utilization of storage facilities for land, marine or aviation object. The system allows an owner to register its facility with parameters. Renter for land, marine or aviation object storage facility can search the system using various parameters.

The main advantages of the present invention are:
1) To provide a system and method that allows owner-input and requisite renter-searchable facility parameters for the storage of land, marine or aviation object.
2) To provide a system and method that enhances real-time determination of vacancy in a facility using Internet-based and geospatial technologies.
3) To provide a system and method that enhances utilization of secure facilities through trusted agents with the requisite qualifications, credentials, certifications, experience, and security clearances.
4) To provide a system and method that is open and scalable to add-on components such as Artificial Intelligence (AI), Virtual Reality (VR) and marketplace tools.

### BRIEF DESCRIPTION OF THE SEVERAL VIEWS OF THE DRAWING

FIG. 1 is the integrated view of the present invention;

FIG. 2 is the integrated schematic view of object storage;

FIG. 3 is the facility registration function;

FIG. 4 is the renter registration function;

FIG. 5 is the trusted agent function;

FIG. 6 is the vacancy request function;

FIG. 7 is the vacancy announcement function;

FIG. 8 is the cancellation function;

### DETAILED DESCRIPTION OF THE INVENTION

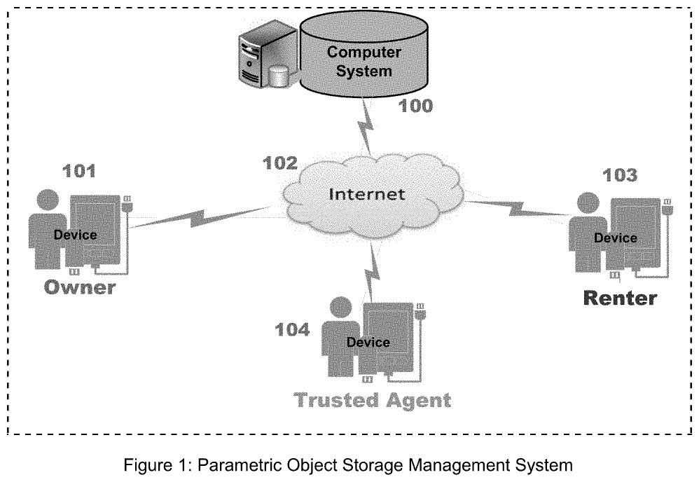

Embodiments depicted in FIGS. 1 to 8 of this invention are described herein with drawings and relevant components, such that those skilled in the art can have an understanding of the parametric object storage management system.

FIG. 1 illustrates the embodiment of the present innovation consisting of a computer system 100; owner 101 uses a device to program operation and receive output from computer system 100 via the Internet 102; renter 103 uses a device to program operation and receive output from computer system 100 via the Internet 102; trusted agent 104 uses a device to program operation and receive output from computer system 100 via the Internet 102.

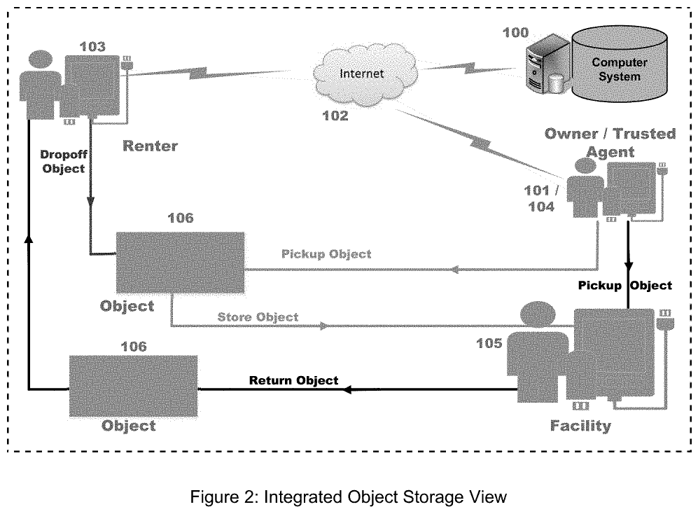

FIG. 2 illustrates the integrated object storage view consisting of a computer system 100; renter 103 submits request from a device to the computer system 100 via the Internet 102; computer system 100 processes request and sends output to the device of an owner 101 or trusted agent 104 via the Internet 102; owner 101 or trusted agent 104 picks-up object 106 from the renter 103 to the facility 105 or picks-up the object 106 from the facility 105 to the renter 103.

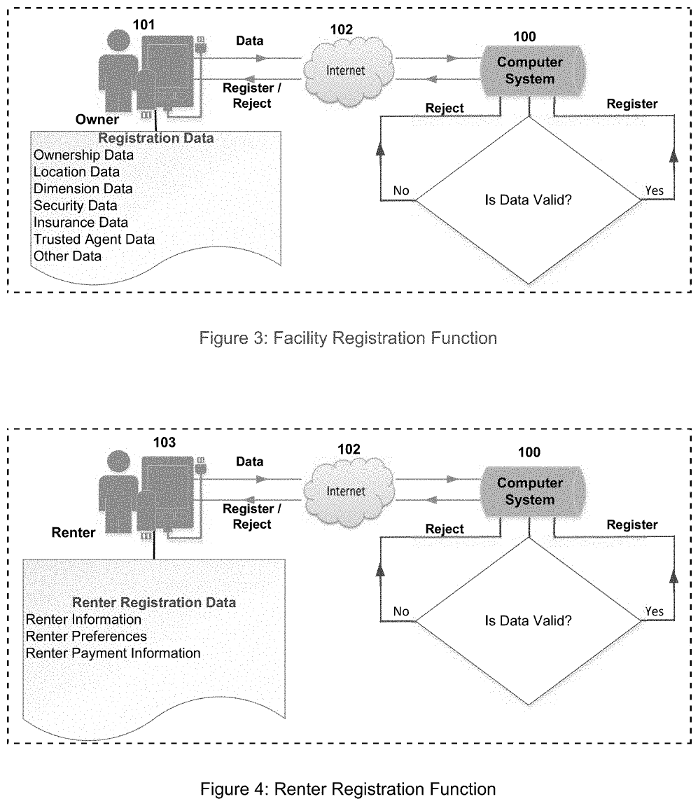

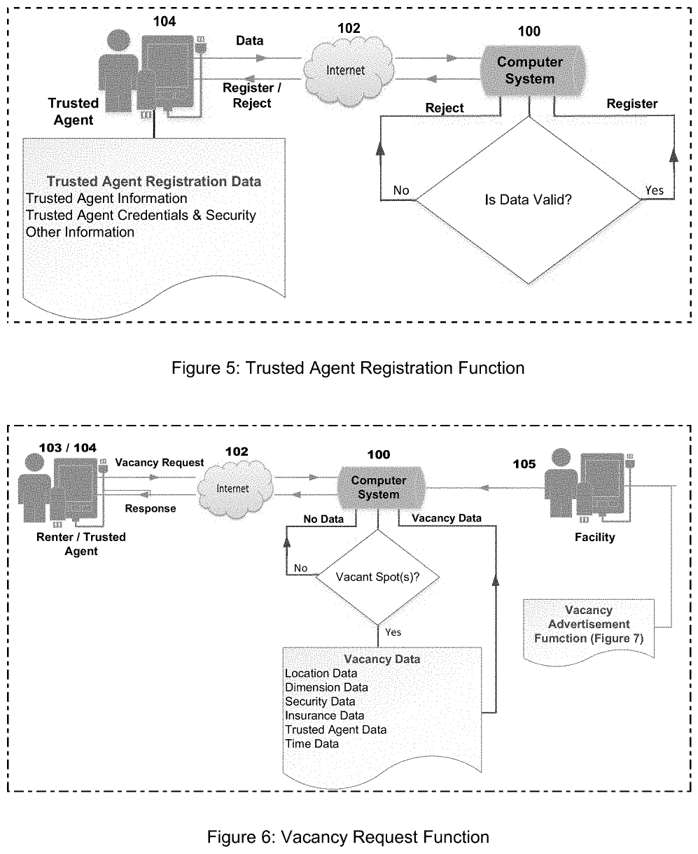

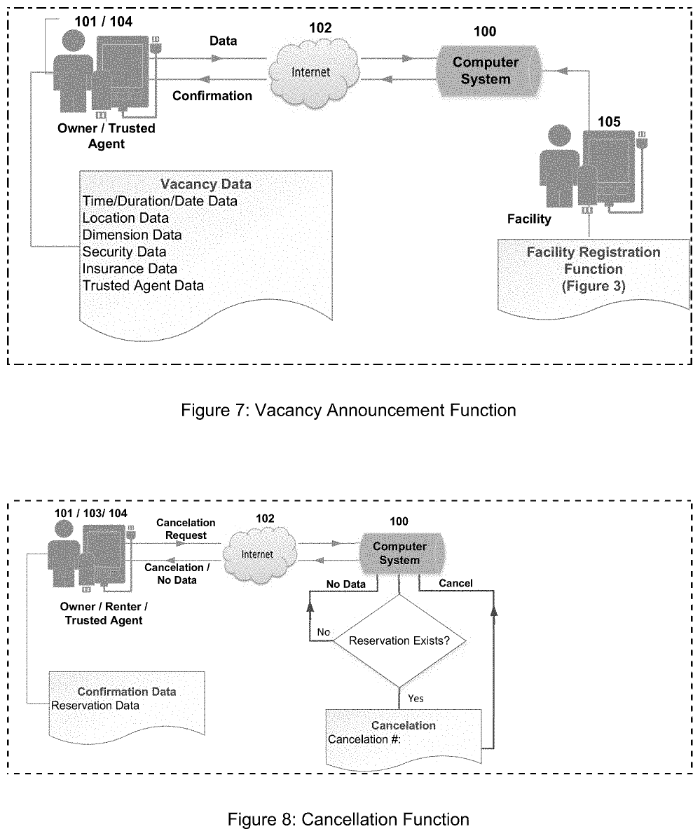

FIG. 3 illustrates the facility registration function consisting of computer system 100; owner 101 submits registration data from a device to the computer system 100 via the Internet 102; computer system 100 processes the registration data and sends the output command to device of the owner 101 via the Internet 102.

FIG. 4 illustrates the renter registration function consisting of computer system 100; renter 103 submits registration data from a device to the computer system 100 via the Internet 102; computer system 100 processes the registration data and sends the output to device of the renter 103 via the Internet 102.

FIG. 5 illustrates the trusted agent registration function consisting of computer system 100; trusted agent 104 submits registration data from a device to the computer system 100 via the Internet 102; computer system 100 processes the registration data and sends the output to device of the trusted agent 104 via the Internet 102.

FIG. 6 illustrates the vacancy request function consisting of computer system 100; renter 103 or trusted agent 104 submits vacancy request data from a device to the computer system 100 via the Internet 102; computer system 100 processes the vacancy request data and sends the output to the device of the renter 103 or trusted agent 104 via the Internet 102.

FIG. 7 illustrates the vacancy announcement function consisting of computer system 100; owner 101 or trusted agent 104 submits vacancy announcement data from a device to the computer system 100 via the Internet 102; computer system 100 processes the vacancy announcement data and sends the output to the device of the owner 101 or trusted agent 104 via the Internet 102.

FIG. 8 illustrates the cancellation function consisting of computer system 100; owner 101, renter 103 or trusted agent 104 submits cancellation data from a device to the computer system 100 via the Internet 102; computer system 100 processes the cancellation data and sends the output to the device of the owner 101, renter 103 or trusted agent 104 via the Internet 102.

What is claimed is:

1. A parametric object storage management system comprising of:
(A) a computer system to process input data and output results;
(B) a device to input data and display output from the computer system;
(C) an Internet connection with the computer system and device;

2. The computer system of claim 1, wherein said computer system comprises computer code library of modules and functions for owner, trusted agent and renter;

3. The modules and functions of claim 2, wherein said functions are computer code library used by the computer system of claim 1 to: register facility; register renter;
register trusted agent; request vacancy; announce vacancy; cancel operation;

4. The facility register functions of claim 3, wherein said functions are computer code library used by the computer system of claim 1 to register the facility;

5. The renter register functions of claim 3, wherein said functions are computer code library used by the computer system of claim 1 to register the renter;

6. The trusted agent register functions of claim 3, wherein said functions are computer code library used by the computer system of claim 1 to register the trusted agent;

7. The vacancy request functions of claim 3, wherein said functions are computer code library used by the computer system of claim 1 to request vacancy;

8. The vacancy announcement functions of claim 3, wherein said functions are computer code library used by the computer system of claim 1 to announce vacancy;

9. The cancel functions of claim 3, wherein said functions are computer code library used by the computer system of claim 1 to cancel an operation;
